(19) United States
(12) Patent Application Publication
(10) Pub. No.: US 2004/0127288 A1
(43) Pub. Date: Jul. 1, 2004

(54) Communication game equipment

(76) Inventors: Shinichi Furuhashi, Tokyo (JP); Keisuke Yasui, Tokyo (JP); Jiro Yoshida, Tokyo (JP); Youichi Tanaami, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/624,508

(22) Filed: Jul. 23, 2003

(30) Foreign Application Priority Data
Jul. 29, 2002 (JP) 2002-220319

(51) Int. Cl. A63F 13/00

(52) U.S. Cl. 463/42

(57) ABSTRACT

A communication game equipment is provided, which is capable of implementing a system for performing real time communication multiplayer communication and real time management monitoring communication while concurrently keeping an equipment load level. The communication game equipment including a main system having a main CPU, which controls execution of games by game programs; and a communication sub-system having a sub-CPU, which executes a plurality of different communication function tasks, wherein the communication sub-system is provided with a shared memory accessible by the main CPU and the sub-CPU, the communication sub-system having a resource management task function, which manages resources of the shared memory for the plurality of different communication function tasks.

### BACKGROUND OF THE INVENTION

1. Field of the Invention

The present invention relates to a game equipment unit having communication functions, and more particularly to a networked game equipment unit.

2. Description of the Related Arts Some communication gaming systems have launched their service which, by providing a plurality of game equipment units, each having a plurality of communication functions, at a game center connected to a database via a network (hereafter simply referred to as communication game equipment), make gaming programs downloaded from the database executable on each game equipment unit or which make multiplayer games playable on the plurality of game equipment units in real time.

Such communication gaming systems are demanded to have (1) a communication function for accessing the database from the communication game equipment and download or upload game data, (2) a communication function for allowing data exchange between adjacent game equipment units at regular intervals and (3) a communication function for sending data from each of the plurality of game equipment units to a POS (Point of Sales) system provided for sales management purposes or conversely downloading new versions of gaming programs from a gaming program database.

Incidentally, if these three communication functions are executed by a main CPU alone, which runs application programs, that is, gaming programs, the main CPU will be naturally heavily loaded.

On the other hand, the three communication functions maybe implemented by separate pieces of hardware. In this case, however, the main CPU will be tasked with managing resources of a shared memory for each piece of the hardware. As a result, the CPU will also be heavily loaded, in this case.

Further, provision of separate pieces of hardware, each of which executes one of the three communication functions, results in high overall equipment cost and complicated handling. Moreover, since driver software for each piece of the hardware interferes with each other, application developers will be burdened or restricted in developing gaming application programs using networks.

To address such problems, however, no techniques have been previously proposed which can implement a system not only for ordinary access communication with a network server but also for communication as game equipment units such as real time communication multiplayer communication and real time management monitoring communication while concurrently keeping equipment load level.

### SUMMARY OF THE INVENTION

It is therefore an object of the present invention to provide a communication game equipment, which can implement the aforementioned three communication functions with a shared function board and which can further keep processing equipment load level when running gaming programs.

In order to achieve the above object, according to a first aspect of the present invention there is provided a communication game equipment including a main system having a main CPU, which controls execution of games by game programs; and a communication sub-system having a sub-CPU which executes a plurality of different communication function tasks, wherein the communication sub-system is provided with a shared memory accessible by the main CPU and the sub-CPU, the communication sub-system having a resource management task function which manages resources of the shared memory for the plurality of different communication function tasks.

The plurality of different communication function tasks may include a network server access task, which performs data downloads from or uploads to a data center, a real time management monitor task, which exchanges management data with a POS data center, and a real time communication task which executes data sharing with another game equipment unit connected to an adjacent link.

The sub-CPU may be configured such that it is managed by a real time operating system (OS).

The main system and the communication sub-system may be each formed on circuit boards independent of each other.

In order to achieve the above object, according to a second aspect of the present invention there is provided a networked communication game equipment including a data server; a game center connected to the data server via a communication circuit, the game center including a plurality of game equipment units, the plurality of game equipment units in the game center being connected to each other via Ethernet; a main system having a main CPU which controls execution of games by game programs; and a communication sub-system having a sub-CPU which executes a plurality of different communication function tasks, wherein the communication sub-system is provided with a shared memory accessible by the main CPU and the sub-CPU, the communication sub-system having a resource management task function which manages resources of the shared memory for the plurality of different communication function tasks.

It is preferred that the plurality of different communication function tasks include a network server access task which performs data downloads from or uploads to a data center, a real time management monitor task which exchanges management data with a POS data center, and a real time communication multiplayer task which executes data sharing for multiplayer games with another game equipment unit connected to an adjacent link.

It is preferred that the plurality of different communication function tasks include a communication multiplayer task for communication multiplayer games played between the plurality of game equipment units, the communication multiplayer task providing control such that data to be sent is read from the main system by the sub-system when a synchronization request is issued from the main system of each of the plurality of game equipment units, that the data is sent to the game equipment unit connected to an adjacent link, and that data transmission is repeated to the game equipment unit connected to an adjacent link when data of a game equipment unit other than the one's own game equipment unit is received.

Preferably, the communication multiplayer task further provides control such that a life value corresponding to the number of game equipment units playing a communication multiplayer game is added when the data is sent to the game equipment unit connected to an adjacent link, that the life value is decremented only by one on a game equipment receiving the data and that repetitive data transmission is halted when the life value reaches a predetermined value.

The features of the present invention will become more apparent from the embodiment units of the invention, which will be described below with reference to the accompanying drawings.

### BRIEF DESCRIPTION OF THE DRAWINGS

FIG. 1 illustrates a configuration example for a networked communication game equipment to which the present invention is applied;

FIG. 2 illustrates a detailed configuration example within a store 1 shown in FIG. 1;

FIG. 3 illustrates a configuration example, according to the present invention, common to a plurality of all game equipment units GU;

FIG. 4 illustrates a task configuration according to the present invention;

FIG. 5 illustrates a flowchart showing the relationship between processings of tasks 420 to 422 and processings of an application program;

FIG. 6 illustrates an explanatory drawing of a resource management task 410;

FIG. 7 illustrates an explanatory drawing of a network server access task 420;

FIG. 8 illustrates an explanatory drawing of a real time management monitor task 421;

FIG. 9 illustrates an explanatory drawing of data transfer taking place when a multiplayer or other game is played between a plurality of game equipment units; and

FIG. 10 illustrates an explanatory drawing of processings performed between game equipment units A and B, which are connected to links adjacent to each other.

### DESCRIPTION OF THE PREFERRED EMBODIMENT

The embodiments of the present invention will now be described hereinbelow. Note that the configuration shown in the drawings is for understanding of the present invention, and it will be appreciated that the applications of the present invention are not limited to such a configuration.

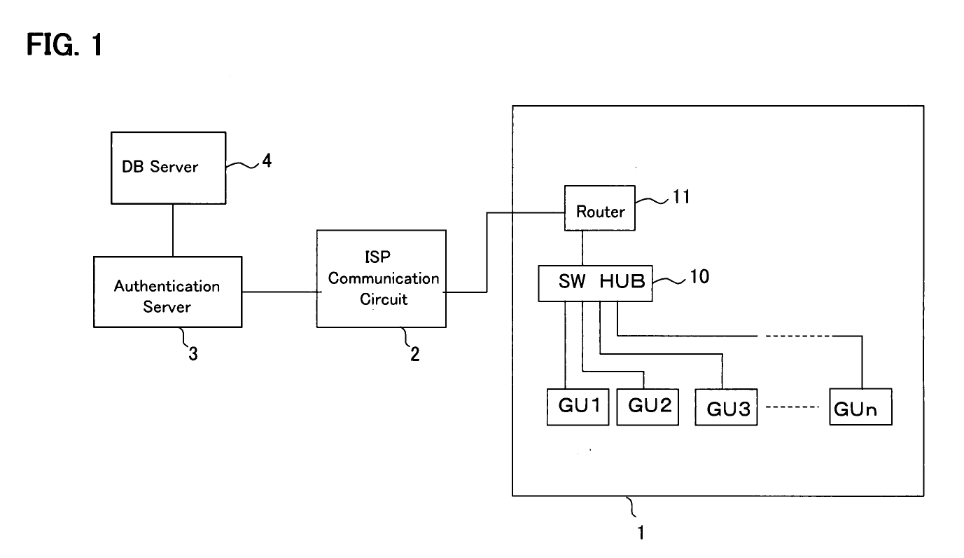

FIG. 1 illustrates a configuration example for a networked communication game equipment, to which the present invention is applied. In the present invention, a plurality of communication game equipment (GU1 to GUn) are provided within a store 1 such as game center and connected to a LAN by means of switching hubs 10, for example, via Ethernet.

The game equipment units are connected to a communication circuit 2 via a router 11 and further connected to an authentication server 3 and a database server 4 via the communication circuit 2.

While a variety of transmission line means are applicable to the communication circuit 2, connection is established by an Internet service provider (ISP) in the case of the Internet. The authentication server 3 prevents unauthorized access to the data server 4.

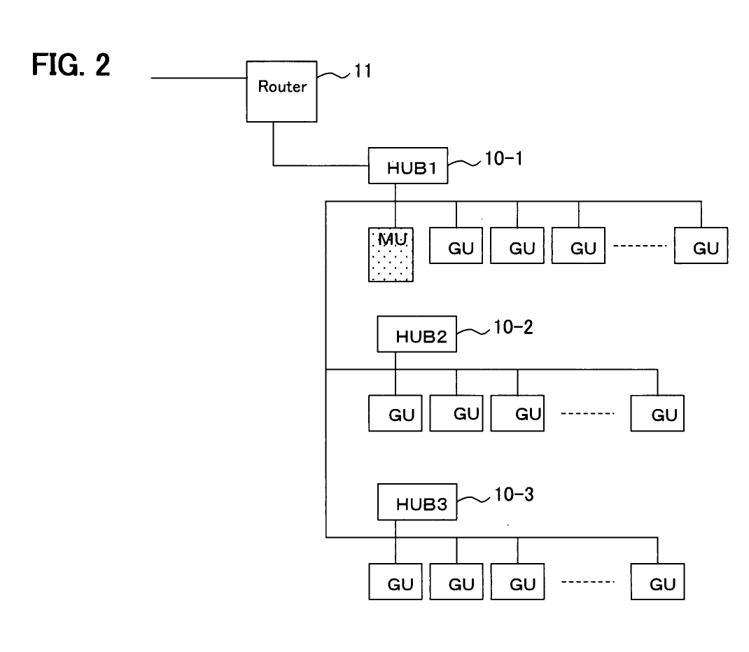

FIG. 2 illustrates a detailed configuration example within the store 1 shown in FIG. 1, to which the present invention is applied. The example in FIG. 2 includes a plurality of cascaded switching hubs 10-1 to 10-3 as the switching hubs 10, and a plurality of game equipment units GU are connected to each of the switching hubs 10-1 to 10-3 via Ethernet.

Further, connection of the switching hub 10-1 to the router 11, for example, allows each of the plurality of game equipment units GU to be connected to the communication circuit 2. In FIG. 2, a management unit MU is connected to the switching hub 10-1. The management unit MU manages the plurality of game equipment units GU within the store 1 and has a POS (Point of Sales) function designed to collect data from each of the communication game equipment for sales management purposes.

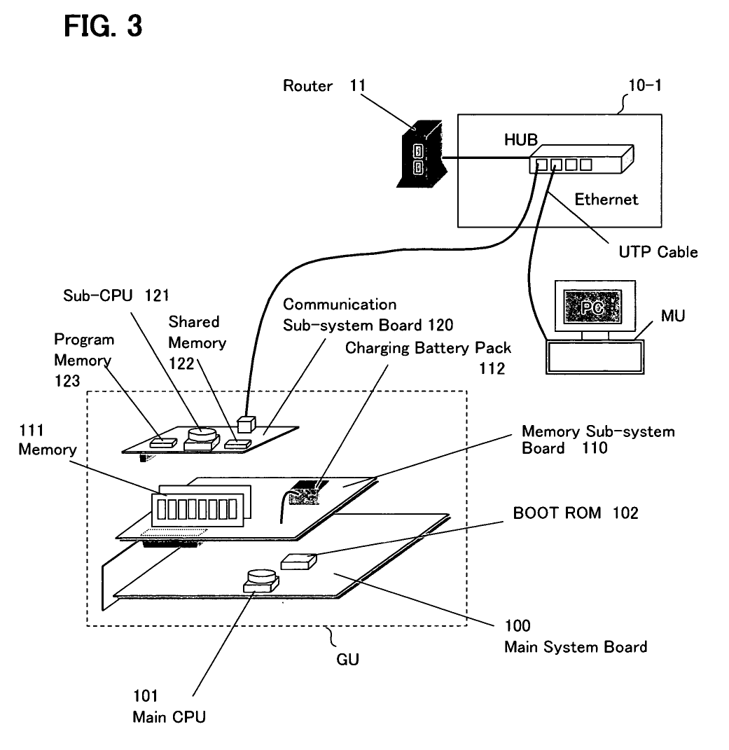

FIG. 3 illustrates a configuration example, according to the present invention, common to a plurality of all the game equipment units GU. The game equipment unit GU has a main system board 100 and a main sub-system board 110, each making up the main system, together with a communication sub-system board 120 added as a sub-system.

The main system board 100 is equipped with a main CPU 10-1 and a boot ROM 102. The sub-system (memory sub-system) board 110, which provides memory functionality, among other things, to the main system board 100, has a main memory 111 and a battery charger pack 112. The main memory 111 stores an application program, that is, a gaming program downloaded from the data server 4 or provided to the management unit MU in the form of a storage medium.

Therefore, execution of the game is controlled by the main CPU 101 according to the downloaded program and based on predetermined operations performed on the game equipment unit by a player.

Further, the sub-system (communication sub-system) 120, providing communication functionality, among other things, has a sub-CPU 121 and executes the three aforementioned communication functions, that is, the communication function for accessing the database 4 and downloading or uploading game data, the communication function for sharing data among adjacent communication game equipment and the communication function for collecting data from each of the communication game equipment into the POS (Point of Sales) system for sales management purposes and downloading new versions of gaming programs from the gaming program database.

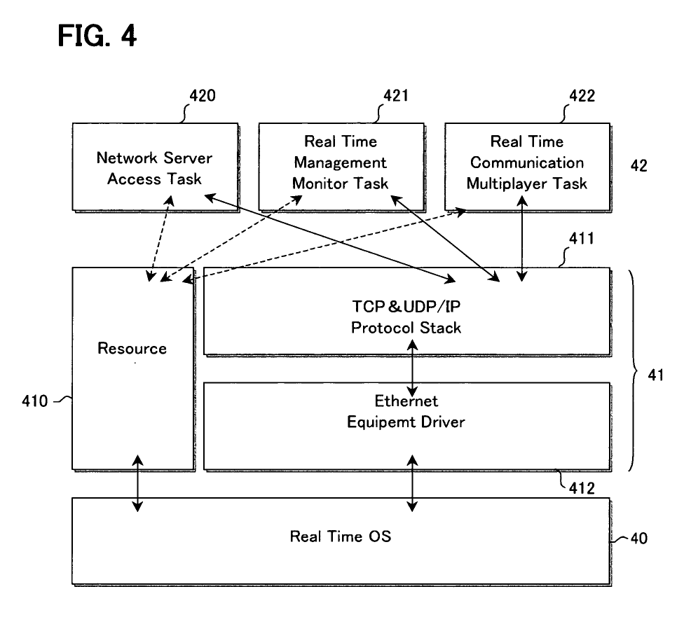

FIG. 4 illustrates a task configuration according to the present invention. The tasks are made up of an OS (operating software) layer 40, a management task layer 41 and a communication task layer 42.

To lay emphasis on real time response capability, the OS (operating software) layer 40 uses real time OS as its OS (operating software). Microsoft Windows CE is among real time OS that can be used.

The management task layer 41 has a resource management task 410, which manages resources of each of the functional sections of the game equipment unit GU, a TCP&UDP/IP protocol stack 411 and an Ethernet equipment driver 412.

There are two protocols, TCP (Transmission Control Protocol) and UDP (User Datagram Protocol), in the TCP&UDP/IP protocol stack 411. The former controls connection-oriented datalink and stream I/O with no data length limitations while the latter controls I/O using a packet format called datagram suitable for connectionless image data.

Further, the communication task layer 42 has a multitasking configuration and a network server access task 420, a real time management monitor task 421 and a real time communication multiplayer task 422.

A program, which executes the tasks 420 to 422 of the communication task layer 42 and the resource management task 410, is stored in a program memory 123 attached to the communication sub-system board 120.

Therefore, the resource management task and the communication tasks are executed without imposing load on the main CPU 101.

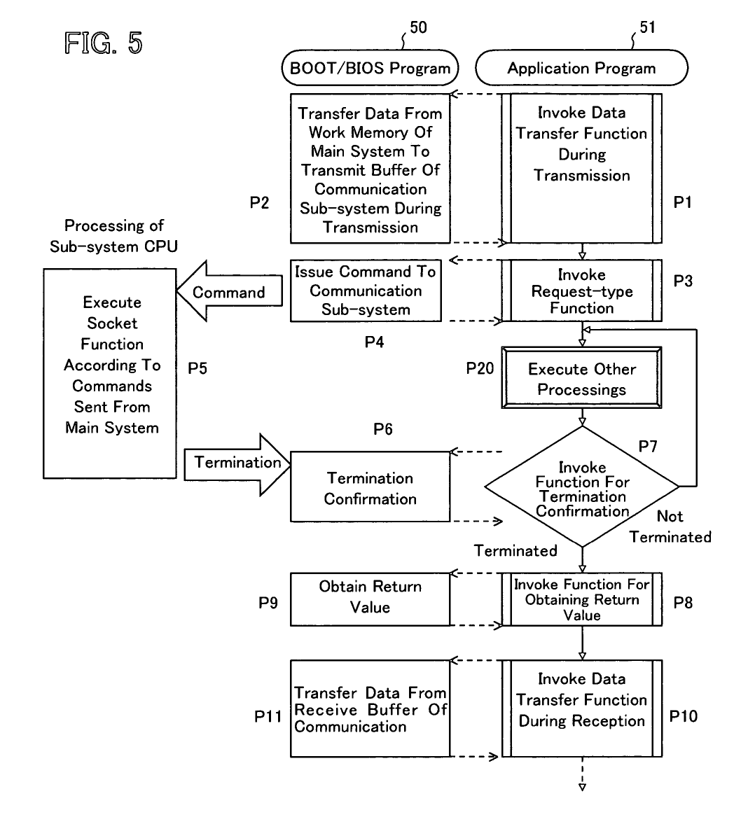

The relationship will be described next with reference to FIG. 5 between processings of the tasks 420 to 422 stored in the program memory 123 of the communication sub-system board 120 and processings of a boot/BIOS (Basic I/O system) program stored in the boot ROM 102 and an application program stored in the work memory 111 in such a configuration of the game equipment unit GU.

Note that the boot/BIOS (Basic I/O system) program 50 and the application program 51 are executed by the main CPU 101.

In FIG. 5, the application program 51 invokes, as an advance processing, a data transfer function when transmitting data only if a data transmit command is executed (process step P1). In response to the processing, the boot/BIOS (Basic I/O system) program 50 transmits the data from the work memory 111 of the main system board 100 to a shared memory 122 of the communication sub-system board 120, the memory having buffer functionality (process step P2).

Then, the application program 51 invokes a request-type function (process step P3) and issues a command to the sub-CPU 121 of the communication sub-system board 120 via the boot/BIOS (Basic I/O system) program 50 (process step P4).

The sub-CPU 121 executes a socket function corresponding to multitasking of the network server access task 420, the real time management monitor task 421 and the real time communication multiplayer task 422 (process step P5). Here, socket refers to a stream-type socket located in a lower layer of the application program 51 and specified by the application program or an API (Application Program Interface) corresponding to a datagram-type socket.

Next, the application program 51 regularly invokes a function for termination confirmation (process step P7) and invokes a function for obtaining a return value (process step P8) when the boot/BIOS (Basic I/O system) program 50 confirms termination of the socket function execution (process step P6), as a result of which the boot/BIOS (Basic I/O system) program 50 obtains the return value (process step P9).

Further, the application program 51 invokes, as a processing performed only when a data receive command is executed, a data transfer function when receiving data (process step P10). Based on this function, the boot program 50 transfers the data from the shared memory 122 of the communication sub-system board 120, the shared memory functioning as a buffer, to the work memory 111 of the main system board 100 (process step P11).

In the processing flow, while the sub-CPU 121 executes the socket function, that is, while the CPU 121 handles connection between ports and data exchange between the connected ports, the application program 51 can perform other processings necessary for the system (process step P20).

A description will now be given below of the processing of the tasks executed by the sub-CPU 211 according to the commands from the application program 51.

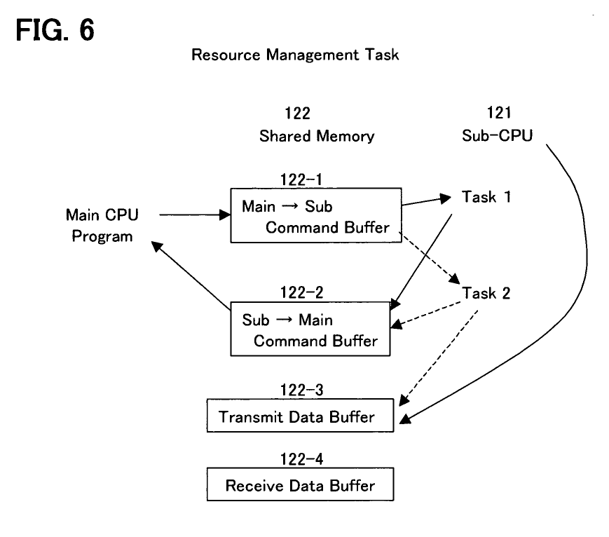

FIG. 6 illustrates an explanatory drawing of the resource management task 410. The shared memory 122 of the communication sub-system 120 has a command buffer 122-1 which buffers commands sent from the main CPU 101 according to the game program, a command buffer 122-2 which buffers commands from the sub-CPU 121, a transmit data buffer 122-3 and a receive data buffer 122-4.

The resource management task 410 preferentially controls the task commands sent from the main CPU 101 according to the resource availability status. In FIG. 6, priority is given to a command for a task 1, restricting the use of the command buffer 122-2 and the buffer 122-3 for a task 2.

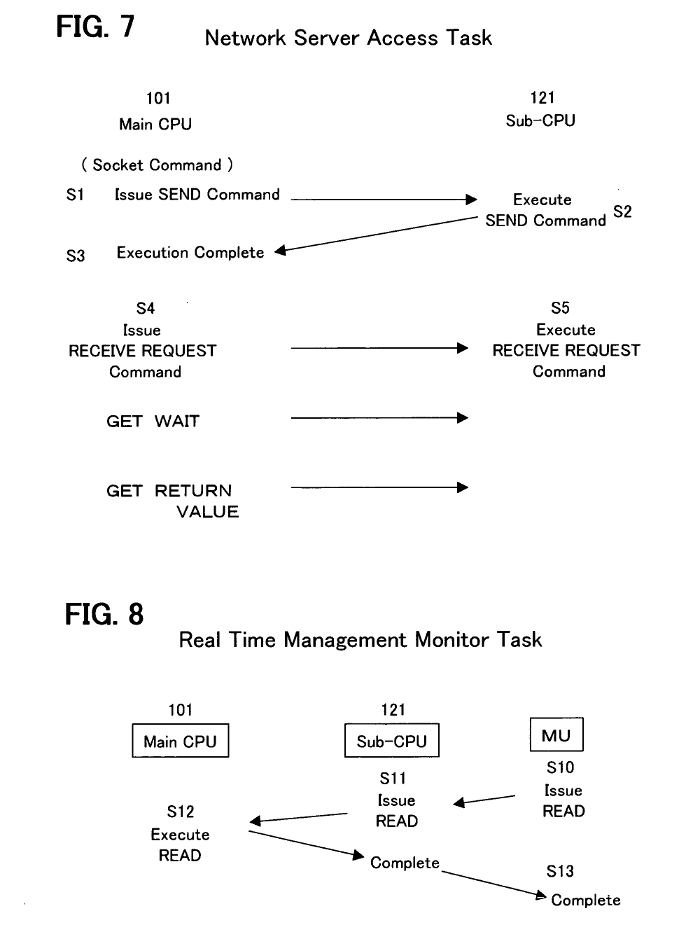

FIG. 7 illustrates an explanatory drawing of the network server access task 420.

The network server access task 420 performs the function for connecting the game equipment unit GU to the data server 4 and downloading or uploading game data or the function for connecting the game equipment unit GU to a URL on the Internet via the router 11.

As described in FIG. 5, the main CPU 101 sends a socket command to the sub-CPU 121 to perform a corresponding task. In the case of data transmission, when the main CPU 101 issues a SEND command (step S1), the sub-CPU 121 executes the SEND command (step S2), thus causing the main CPU 101 to be notified of an execution completion as the return value (step S3).

Alternatively, when the main CPU 101 issues a RECEIVE-REQUEST command (step S4), the sub-CPU 121 executes the RECEIVE-REQUEST command (step S5). Then, the main CPU 101 issues a GET WAIT (termination confirmation), a GET RETURN VALUE (return value acquisition) or other command in the network server access task 420.

FIG. 8 illustrates an explanatory drawing of the real time management monitor task 421. This task performs, based on access from the management unit MU, a function for sending operation status data of the game equipment unit GU to the management unit MU. In such a case, the management unit MU issues the READ command to the sub-CPU 121 (step S10). The sub-CPU 121 sends the command as is to the main CPU 101 (step S11).

Therefore, the main CPU 101 executes the READ command (step S12) and sends a completion notice to the management unit MU via the sub-CPU 121 (step S13). This allows status data of the game equipment unit GU to be collected. Further, the real time communication multiplayer task 422 is updated between the game equipment unit GU and the other equipment unit connected to an adjacent link at fixed intervals in a multiplayer game and handles communication between the game equipment units for data sharing.

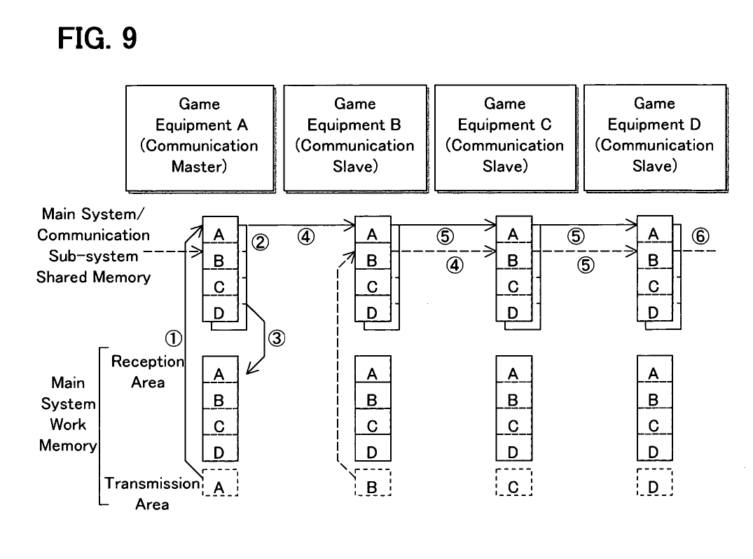

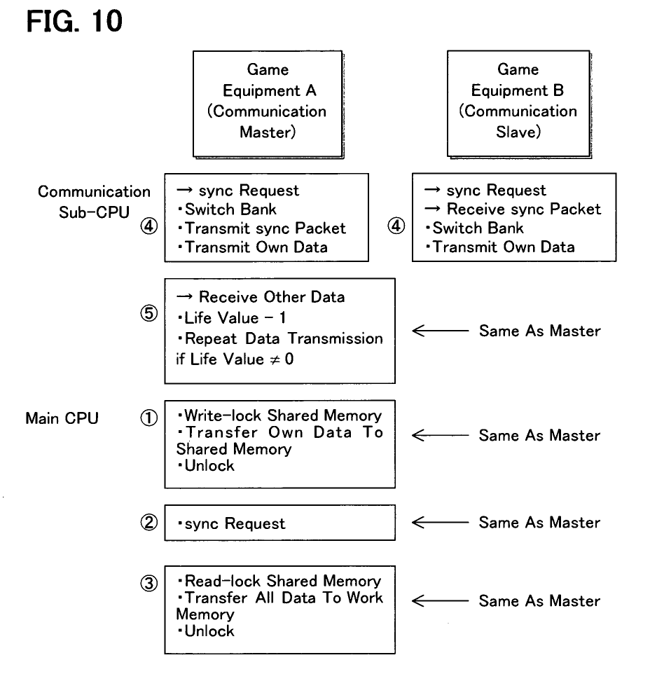

Next, a description will be given of an example of data transfer by the real time communication multiplayer task 422 in relation to the application of the present invention with reference to FIGS. 9 and 10 when a multiplayer or other game is played between a plurality of game equipment units.

FIG. 9 illustrates an explanatory drawing of data transfer taking place when a multiplayer or other game is played between a plurality of game equipment units A to D. FIG. 10 illustrates an explanatory drawing of processings performed between the game equipment units A and B, which are connected to links adjacent to each other, and the same processings are performed between the other game equipment units connected to links adjacent to each other.

In FIG. 9, the plurality of game equipment units A to D are connected to one another via Ethernet. Of the plurality of game equipment units A to D, the game equipment unit A is set up as a communication master while the other game equipment units B to D are set up as communication slaves.

In FIG. 10, the main CPU 101 of the game equipment unit A declares a write to the shared memory 122 (write lock) and transfers data A from the work memory 111 to the shared memory 122 (step (1)). At this time, since the main CPU 101 performs the write, access from the sub-CPU 121 is inhibited (unlock). Next, the main CPU 101 sends a SYNC request command to the sub-CPU 121 (step (2)).

Further, the main CPU 101 loads all new data in the shared memory 122 received from the game equipment units other than the own equipment unit into the work memory 111 of the main system board 100 (step (3)).

The sub-CPU 121 switches banks of the shared memory 122, transmits a SYNC packet to the adjacent game equipment B and then transmits data of the own equipment unit to the game equipment unit B. On the other hand, if the sub-CPU 121 receives data of the game equipment other than the own equipment unit, the sub-CPU 121 repeats data transmission to the next game equipment unit(step (4)).

When the game equipment unit A sends its own data to the adjacent game equipment unit, a predetermined life value is set in the data to be sent which corresponds to the number of the game equipment units.

Upon receipt of the SYNC request and the SYNC packet, the adjacent game equipment unit B switches banks of the shared memory 122 and transmits its own data from the shared memory 122 to the game equipment unit C (step (4)) On the other hand, the game equipment unit B receives the data from the game equipment unit A in the previous stage. Further, when the game equipment unit B receives data from the other game equipment units, the game equipment unit B decrements the life value only by one (step (5)). If the life value becomes equal to 0 as a result of the decrementation, this means that the game equipment unit is at the last stage of the link, and the data has already been sent to the other game equipment units. In such a case, therefore, no more data transfer will take place (step (6)).

Similarly in FIG. 9, if data B is updated in the game equipment B, the data B is sequentially transferred to the adjacent game equipment unit C.

Thus, data updated at fixed intervals can be shared among a plurality of game equipment units participating in a multiplayer game.

As described above in the embodiments according to the drawings, the present invention can provide the game equipment unit capable of implementing the system for performing the real time communication multiplayer communication and the real time management monitoring communication while concurrently keeping the equipment load level.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A communication game equipment comprising:
a main system having a main CPU, which controls execution of games by game programs; and
a communication sub-system having a sub-CPU, which executes a plurality of different communication function tasks,
wherein the communication sub-system is provided with a shared memory accessible by the main CPU and the sub-CPU, the communication sub-system having a resource management task function, which manages resources of the shared memory for the plurality of different communication function tasks.

2. The communication game equipment according to claim 1, wherein the plurality of different communication function tasks include a network server access task, which performs data downloads from or uploads to a data center, a real time management monitor task, which exchanges management data with a POS data center, and a real time communication task, which executes data sharing with another game equipment unit connected to an adjacent link.

3. The communication game equipment according to claim 1 wherein the sub-CPU is configured such that it is managed by a real time operating system (OS).

4. The communication game equipment according to claim 1, wherein the main system and the communication sub-system are each formed on circuit boards independent of each other.

5. A networked communication game equipment comprising:
a data server;
a game center connected to the data server via a communication circuit, the game center including a plurality of game equipment units, the plurality of game equipment units in the game center being connected to each other via Ethernet;
a main system having a main CPU which controls execution of games by game programs; and
a communication sub-system having a sub-CPU which executes a plurality of different communication function tasks,
wherein the communication sub-system is provided with a shared memory accessible by the main CPU and the sub-CPU, the communication sub-system having a resource management task function, which manages resources of the shared memory for the plurality of different communication function tasks.

6. The networked communication game equipment according to claim 5,
wherein the plurality of different communication function tasks include;
a network server access task, which performs data downloads from or uploads to a data center;
a real time management monitor task, which exchanges management data with a POS data center; and
a real time communication multiplayer task, which executes data sharing for multiplayer games with another game equipment unit connected to an adjacent link.

7. The networked communication game equipment according to claim 5,
wherein the plurality of different communication function tasks include;
a communication multiplayer task for communication multiplayer games played between the plurality of game equipment units; and
wherein the communication multiplayer task provides control such that data to be sent is read from the main system by the sub-system when a synchronization request is issued from the main system of each of the plurality of game equipment units, that the data is sent to the game equipment unit connected to an adjacent link, and that data transmission is repeated to the game equipment unit connected to an adjacent link when data of a game equipment unit other than the one's own game equipment unit is received.

8. The networked communication game equipment according to claim 7,
wherein the communication multiplayer task further provides a control such that a life value corresponding to the number of game equipment units playing a communication multiplayer game is added when the data is sent to the game equipment unit connected to an adjacent link, that the life value is decremented only by one on a game equipment unit receiving the data and that repetitive data transmission is halted when the life value reaches a predetermined value.
